(19) United States
(12) Patent Application Publication
(10) Pub. No.: US 2021/0076642 A1
(43) Pub. Date: Mar. 18, 2021

(54) Training apparatus

(71) Applicant: Erin Cathleen Ogram, Scottsdale, AZ (US)

(72) Inventor: Erin Cathleen Ogram, Scottsdale, AZ (US)

(21) Appl. No.: 16/602,330

(22) Filed: Sep. 16, 2019

(51) Int. Cl. A01K 27/00; A01K 15/02; A01K 13/00; G08B 7/06; G08B 21/18

(52) U.S. Cl. CPC A01K 27/009; A01K 15/021; G08B 21/182; A01K 27/002; G08B 7/06; A01K 13/006

(57) ABSTRACT

A training apparatus for an animal having a vest or halter adapted to be worn by the animal. IN one embodiment, three or more alert mechanisms (vibrators or sound generators) are embedded into the vest, over both shoulders and one on the chest. Through remote control, the alert mechanisms are selectively activated to direct the animal to go, turn left, turn right, or stop. In one embodiment, a distance measuring mechanism warns the animal of an impending wall or an impending drop-off.

### BACKGROUND OF THE INVENTION

Training animals for whatever reason is often difficult. This is particularly true for animals which are handicapped in one of the senses such as sight or hearing.

As example, dogs which are blind do surprisingly well in learning their environment and navigating their way through familiar surroundings such as the apartment or house. Once in a strange environment though their handicap becomes all too apparent. The dog literally walks until it runs into something.

The owners try their best to assist the blind dog with voice commands but these are often distorted by walls and objects. The dog may want to respond to the owner's voice but are confused by where the source of voice is due to echoes.

This echo and distortion is only made more pronounce when a step or “cliff” is encountered.

Even simple actions such as walking into a wall is frustrating to the owner who cannot maintain constant vigilance of the animal.

It is clear there is a significant need for a mechanism which will assist the training of animals and especially handicapped animals.

### SUMMARY OF THE INVENTION

The invention is a training apparatus for an animal having a vest or halter adapted to be worn by the animal. In one embodiment, three or more vibrators are embedded into the vest, over both shoulders and one on the chest. Through remote control, the vibrators are selectively activated to direct the animal to go left, go right, or stop. In one embodiment, a distance measuring mechanism warns the animal of an impending wall or an impending drop-off.

Within this discussion, a vibrator is used as an “alert mechanism”. A sound generator is also contemplated within the following discussion. While the discussion is for a vibrator, the invention is not limited to solely vibrators.

Within this discussion, a dog is used as the animal being trained but the invention is not limited to only dogs but includes any domesticated animal whether they have a handicap or not.

The training apparatus of this invention is ideally a vest adapted to be worn over the shoulders an or over the ribs of the dog. Included within the vest are at least two remotely controlled vibrators.

Those of ordinary skill in the art readily recognize a variety of vests which can be used in this context, including, but not limited to those described in: U.S. Pat. No. 6,123,049, issued Sep. 26, 2000, to Slater and entitled “Bullet Proof Canine Vest”; U.S. Pat. No. 9,004,016, issued Apr. 14, 2015, to Straiton et al. and entitled “Dog Vest with Integrated Flexible Bumper”; and, U.S. Pat. No. 7,325,516, issued Feb. 5, 2000, to Moore and entitled “Mobility Assistance Vest for the Lame or Elderly Animal”; all of which are incorporated hereinto by reference.

The preferred number of vibrators is four. The four vibrators are positioned on the vest to address the back proximal to the neck (an alternative embodiment places the vibrator on the chest); the back proximal to the tail; and two for the ribs or the shoulder.

In one embodiment, a single sound generator is used. The sound generator is able to emit various tones which the animal is trained for: G, LEFT, RIGHT, STOP.

Remote controlled vibrators are well known to those of ordinary skill in the art, including but not limited to those described in: U.S. Pat. No. 7,378,954, issued May 27, 2008, to Wendt and entitled “Safety Indicator and Method”; U.S. Pat. No. 7,643,795, on Jan. 5, 2010, to Freidrichs, et. Al and entitled “Remote-control Vibrator”; and, U.S. Pat. No. 6,151,278, on Nov. 21, 2000, to Najarian and entitled “Remote Device for Silent Awakening”; all of which are incorporated hereinto by reference.

The owner/user is able to selectively activate the various vibrator to:
GO: vibrator near the tail (alternatively vibrating by both legs);
STOP: vibrator near the neck (in the alternative embodiment, vibrate the chest vibrator);
TURN LEFT: vibrator on left rib/shoulder;
TURN RIGHT: vibrator on the right rib/shoulder;
DOWN: vibrate on the back/spine.

This selective activation of the vibrators is ideally accomplished via a receiver mounted to the vest. The receiver is adapted to respond to: radio wave (issued from the handheld embodiment), voice commands, or ultrasonic sounds generated by a “dog whistle”.

Those of ordinary skill in the art readily recognize a variety of mechanism which may be utilized to receive a variety of input in this context, including, but not limited to: U.S. Pat. No. 9,812,129, issued Nov. 7, 2017, to Engelhardt et al. and entitled “Motor Vehicle Device Operation with Operating Instructions”; U.S. Pat. No. 9,824,685, issued to Stracke, Jr. and entitled “Handsfree Device with Continuous Keyword Recognition”; and, U.S. Pat. No. 9,824,689, issued Nov. 21, 2017, to Shapiro and entitled Speech Recognition for Avionic Systems”; all of which are incorporated hereinto by reference.

For the handheld embodiment, a transmitter is used to send radio waves which are received by the receiver on the vest. The hand-held transmitter interfaces with the operator ideally by buttons or alternatively via a joy-stick

In an enhanced embodiment, a distance measuring device is also secured to vest. The distance measuring device is ideally suited for the situation where the animal is left to roam about a new environment.

Those of ordinary skill in the art recognize a variety of mechanisms which establish a distance to a remote body, including, but limited to those described in: U.S. Pat. No. 9,832,455. Issued Nov. 28, 2017, to Liu et al. entitled “Stereo Camera and Automatic Range Finding Method for Measuring a Distance between Stereo Camera and Reference Plane”; U.S. Pat. No. 9,817,124, issued Nov. 14, 2017, to Takemura et al. and entitled “Distance Measuring Apparatus”; and, U.S. Pat. No. 89,787,951, issued Oct. 10, 2017, to Kannon et al. entitled “Vehicle Proximity Warning System”; all of which are incorporated hereinto by reference.

In one embodiment, the electronic distance measuring apparatus emit a reflective beam parallel to a path of the animal. To alert the animal that a barrier (a wall or a piece of furniture, is eminent, the vibrator on the chest (STOP) is activated. This prevents the animal from running wall and furniture which might injure the animal.

On the other side of the warning, the electronic distance measuring apparatus in a downward direction to warn the animal of a step or “cliff”. The chest vibrator (STOP) is activated in this embodiment when the distance measuring apparatus indicates a distance greater than a prescribed amount.

The invention, together with various embodiments thereof, will be more fully explained by the following drawings and the associated description thereof.

### DRAWINGS IN BRIEF

FIGS. 1A and 1B illustrate the vest/harness on a dog.

FIGS. 2A, 2B, and 2C illustrate various techniques for controlling the vest/harness of FIGS. 1A and 1B.

FIGS. 3A and 3B illustrate the embodiment where a distance sensor is utilized on the vest/harness.

### DRAWINGS IN DETAIL

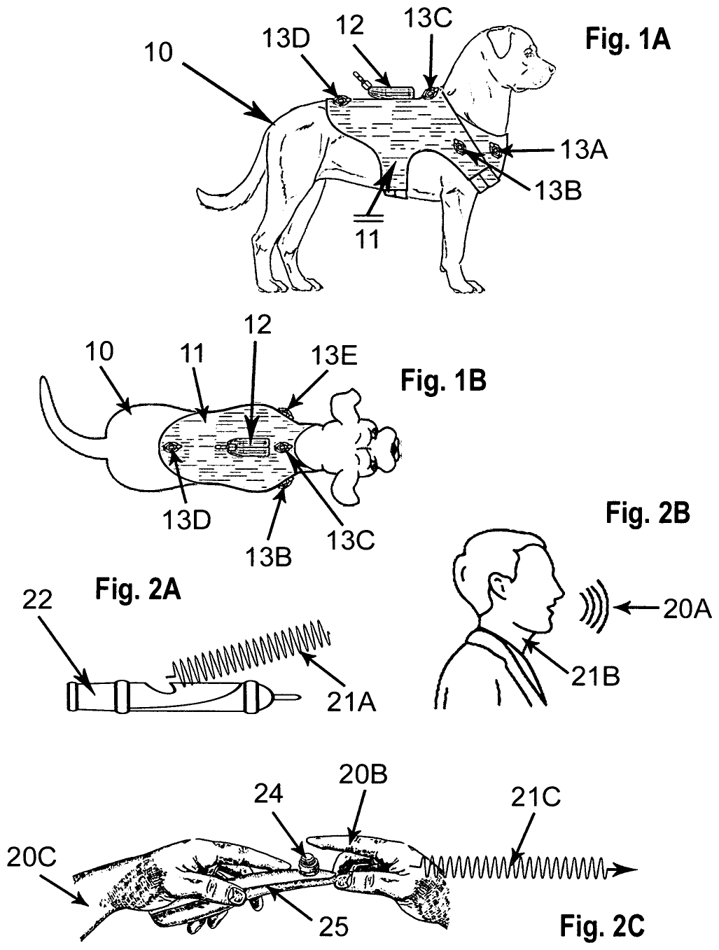

FIGS. 1A and 1B illustrate the vest/harness on a dog. Dog 10 has vest 11. Vest 11, is equipped with a receiver 12 which selectively activates the vibrators 13A, 13B, 13C, 13D and 13E.

Commands for dog 10 include such activities as:
GO: Vibrator 13D
TURN LEFT: Vibrator 13E
TURN RIGHT: Vibrator 13B
STOP: Vibrator 13A
LIE DOWN: Vibrator 13C

Although this arrangement is ideal for this embodiment, those of ordinary skill in the art readily recognize a variety of combinations.

Also, this embodiment utilizes five commands, Other embodiments can use two or more vibrators. In the case of two vibrators located on the ribs of the dog on opposing sides. In this embodiment, the commands to the dog are:
GO: Left and right vibrators constantly activated
TURN LEFT: Left Vibrator Constantly activated
TURN RIGHT: Right Vibrator Constantly activated
STOP: Left Vibrator and Right Vibrator alternately activated
LIE DOWN: Left Vibrator and Right Vibrator simultaneously activated for short periods

FIGS. 2A, 2B, and 2C illustrate various techniques for controlling the vest/harness of FIGS. 1A and 1B.

FIG. 2A illustrates a “Dog whistle” 22 which emits an ultrasonic signal 21A when blown into 22. The receiver 12 is adapted to translate these signals to cause the appropriate vibrators to work as described.

In FIG. 2B, operator 20A issues voice command 21B or whistles which interact with receiver 12 to control the vibrators.

The handheld emitter 25 of FIG. 2C shows emitter being held by operator 20C. Operator 20B is able to manipulate the joy stick 24 which communicates via radio waves 21C to again interact with receiver 12 for the control of the animal.

In practice, the user purchases the package of receiver and transmitter. The receiver is placed onto vest 11. The transmitter is able to communicate with the receiver wirelessly.

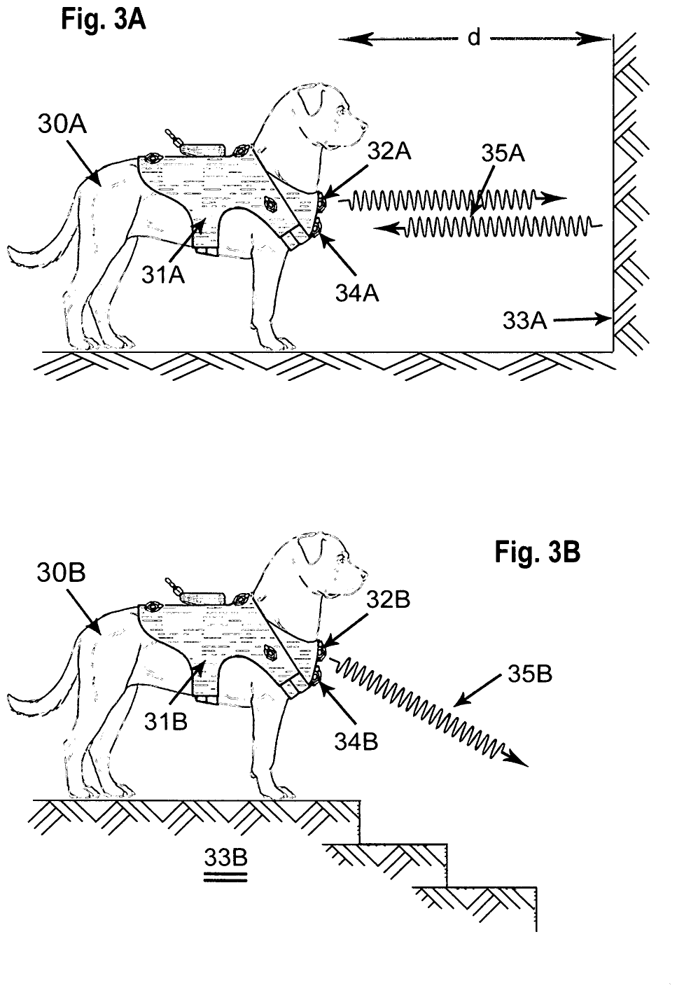

FIGS. 3A and 3B illustrate the embodiment where a distance sensor is utilized on the vest/harness.

The embodiment of FIG. 3A is designed to assist the animal in navigating around walls and other obstacles. Dog 30A has vest 31A which supports a distance sensor 32A. The distance sensor sends out signals substantially in line with the dog's heading and parallel with the ground. The distance sensor looks are the reflections 35A to determine the distance to wall 33A. When the distance becomes too small, indicating a barrier in near proximity, vibrator 34A to alerts the animal to avoid the barrier.

In this embodiment, a beeper or sound generator may be used in lieu of a vibrator 34A.

The animal of FIG. 3B uses a vest with the distance sensor 32B pointing downward 35B. When the distance increases dramatically, vibrator 34B is activated warning the dog of an impending step or a cliff.

It is clear that the present invention provides a mechanism which assists in the training of animals and especially handicapped animals.

What is claimed is:

1. A training apparatus for an animal comprising:
a) a vest adapted to be worn by an animal;
b) at least two remotely controlled alert mechanisms secured to the vest such that, when said vest is worn by the animal any of the at least two remotely controlled alert mechanisms are activated, they are sensed by the animal; and,
c) an operator controlled remote control adapted to selectively activate at least one of the remotely controlled alert mechanisms.

2. The training apparatus for an animal according to claim 1, wherein the alert mechanisms emits as sound.

3. The training apparatus for an animal according to claim 1, wherein the alert mechanisms vibrate.

4. The training apparatus for an animal according to claim 1, further including a receiver secured to the vest and communicating with each of the at least two remotely controlled alert mechanism and wherein said receiver is responsive to a human voice.

5. The training apparatus for an animal according to claim 1, further including a receiver secured to the vest and communicating with each of the at least two remotely controlled alert mechanisms and wherein said receiver is responsive ultrasonic signals.

6. The training apparatus for an animal according to claim 1,
a) further including: a receiver secured to the vest and communicating with each of the at least two remotely controlled alert mechanisms; and,
b) wherein the operator controlled remote control is handheld and communicates with the receiver via radio waves.

7. The training apparatus for an animal according to claim 6, further including shoulder alert mechanisms which are positioned proximate to each of the animal's shoulder.

8. The training apparatus for an animal according to claim 7, further including a breast vibrator being one of the at least two remotely controlled alert mechanism and positioned on the vest such that when said vest is worn by the animal, the breast vibrator is proximal to a breast of the animal.

9. The training apparatus for an animal according to claim 8, further including an electronic distance measuring apparatus directed parallel to a path of the animal, said distance measuring apparatus activating the breast vibrator when the distance measuring apparatus indicates a distance less than a prescribed distance.

10. The training apparatus for an animal according to claim 8, further including an electronic distance measuring apparatus directed parallel and downward to a path of the animal, said distance measuring apparatus activating the breast vibrator when the distance measuring apparatus indicates a distance greater than a prescribed distance.

11. A training apparatus for an animal comprising:
a) a halter adapted to be worn by an animal, said halter having two side vibrators, each side vibrator positioned proximal to ribs of the animal, a breast vibrator positioned proximal to a breast of the animal, and a tail vibrator positioned proximal to a tail of the animal, the shoulder vibrators, the breast vibrator, and the tail vibrator all being remotely activated;
b) an operator controlled remote control mechanism adapted to selectively activate at least one of the vibrators in the halter.

12. The training apparatus for an animal according to claim 11, further including a receiver secured to the halter and communicating with each of the vibrators.

13. The training apparatus for an animal according to claim 12, wherein the halter further includes a distance measuring apparatus generating a signal indicative of a distance from the animal to a remote barrier, said distance measuring apparatus activating the breast vibrator when the distance measuring apparatus indicates a distance less than a prescribed distance.

14. The training apparatus for an animal according to claim 12, further including an electronic distance measuring apparatus targeting a location in front of a foot of the animal, said distance measuring apparatus activating the breast vibrator when the distance measuring apparatus indicates a distance greater than a prescribed distance.

15. A training apparatus for an animal comprising: a vest adapted to be worn over the shoulders of the animal and having two shoulder vibrators, each shoulder vibrator being proximal to a shoulder of the animal and a breast vibrator positioned proximal to a breast of the animal, the shoulder vibrators and the breast vibrator being remotely activated; and an operator controlled remote control adapted to selectively activate at least one of the remotely controlled vibrators.

16. The training apparatus for an animal according to claim 15, further including a receiver secured to the vest and communicating with each of the vibrators and wherein said receiver being responsive to a human voice.

17. The training apparatus for an animal according to claim 15, further including a receiver secured to the vest and communicating with each of the vibrators and wherein said receiver is responsive ultrasonic signals.

18. The training apparatus for an animal according to claim 15,
a) further including a receiver secured to the vest and communicating with each of the vibrators; and,
b) Wherein the operator controlled remote control is handheld and communicates with the receiver via radio waves.
